(19) United States
(12) Patent Application Publication
(10) Pub. No.: US 2020/0193462 A1
(43) Pub. Date: Jun. 18, 2020

(54) System and Method for Mobile Recycling Validation

(71) Applicant: PepsiCo, Inc., Purchase, NY (US)

(72) Inventors: Martin Eduardo BROEN, New York, NY (US); Ryan James CAMPBELL, New York, NY (US); Marco CIMATTI, Sleepy Hollow, NY (US); Christopher NOBLES, Brooklyn, NY (US); Christian STOLARZ, Brooklyn, NY (US)

(21) Appl. No.: 16/221,297

(22) Filed: Dec. 14, 2018

(51) Int. Cl. G06Q 30/02; G06Q 10/00; G06K 7/10; H04W 4/02

(52) U.S. Cl. CPC G06Q 30/0208; G06Q 10/30; G06Q 30/0215; G06Q 50/01; G06K 7/10544; H04W 4/025; G06Q 30/0239

(57) ABSTRACT

A mobile recycling validation system including a mobile recycling application operating on a user's mobile device, at least one server remote from the mobile device, where the mobile recycling application may receive image data relating to an image captured with a camera of the mobile device, identify a unique code printed on a recyclable item depicted in the image, determine unique code data relating to the unique code, determine recycling deposit confirmation data, and send the unique code data and the recycling deposit confirmation data to the server. The server may receive the unique code data and the recycling deposit confirmation data, determine if the unique code is valid, determine if the recycling deposit confirmation data indicates that the recyclable item has been deposited in the recycling stream, and send validation data to the mobile recycling application, which may credit an account of the user with an incentive credit.

### FIELD

Embodiments described herein generally relate to mobile applications for tracking a user's recycling. Specifically, embodiments described herein relate to mobile applications for validating whether a user has recycled an item, and rewarding the user for recycling.

### BACKGROUND

Plastic bottles and aluminum cans are commonly used to package many types of consumer products, such as foods, beverages, household cleaners, grooming products, and more. Plastic and aluminum have many advantages as a packaging material; however, these bottles and other recyclable articles are often thrown away in the garbage instead of being recycled.

### BRIEF SUMMARY

The present disclosure is directed to systems and methods for tracking a user's recycling habits, and validating whether the user has actually recycled an item instead of throwing it away in the garbage. The system may include a mobile application operating on a mobile device, which may utilize a camera built in to the mobile device to capture image data, which may be sent to a server remote from the mobile device. The server may analyze the image data for validity and then provide a user of the mobile application with an incentive credit (e.g., by crediting an account of the user).

Some embodiments are directed to a mobile recycling validation system having a mobile recycling application operating on a user's mobile device and at least one server remote from the mobile device. The mobile recycling application may be configured to receive image data relating to an image captured with a camera of the mobile device, identify a unique code printed on a recyclable item depicted in the image, determine unique code data relating to the unique code, determine recycling deposit confirmation data (which may include, e.g., data that can be used to indicate whether the recyclable item has been deposited in a recycling stream), and send the unique code data and the recycling deposit confirmation data to the at least one server. The at least one server may be configured to receive the unique code and the recycling deposit confirmation data, determine if the unique code is valid, determine if the recycling deposit confirmation data indicates that the recyclable item has been deposited in the recycling stream, and send validation data to the mobile recycling application (validation data may include, e.g., an indication of whether the unique code was determined to be valid and whether the recyclable item was determined to have been deposited in the recycling stream). If the validation data indicates that the unique code was determined to be valid and that the recyclable item was determined to have been deposited in the recycling stream, the mobile recycling validation system may credit an account of the user with an incentive credit.

Some embodiments are directed to a method for mobile validation of recycling. The method may include processing image data relating to a recyclable item to determine if the recyclable item is eligible for an incentive credit, processing data relating to a recycling container to determine if the recyclable item has been deposited in a recycling stream, and—if the recyclable item has been determined to have been deposited in a recycling stream—crediting an account of a user with an incentive credit.

Some embodiments are directed to a mobile recycling validation system including recyclable bottles and cans, a mobile recycling application, and server remote from the mobile device. The bottles and cans may each have a unique code. The mobile recycling application may be configured to receive image data relating to images captured with a camera of a mobile device. And the server may be configured to receive and analyze data from the mobile recycling application to determine whether it includes image data that depicts a bottle or can with a valid unique code and data indicating that the bottle or can was recycled.

### BRIEF DESCRIPTION OF THE DRAWINGS

FIG. 1 shows a mobile recycling validation system according to some embodiments.

FIG. 2 illustrates communication between components of the mobile recycling validation system of FIG. 1.

FIG. 3 is a diagram demonstrating a recycling validation process executed by the mobile recycling validation system of FIG. 1.

FIG. 4 is a representation of a mobile device.

### DETAILED DESCRIPTION

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

Plastic, aluminum, and other recyclable materials are commonly used to make many types of consumer products. In particular, plastic and aluminum are often used to make bottles and cans for soft drinks and other beverages due to their low permeability and high structural strength. These materials also have the advantage of being easily recycled, and such recycling benefits the environment. However the decision whether to place a bottle, can, or other recyclable article to a recycle stream is often up to the individual end user. Some embodiments described herein help to incentivize such end users to place their recyclable articles in a recycling stream, thereby increasing overall recycling and benefiting the environment. Such embodiments provide a seamless, easy-to-use incentive system that rewards end users for validly recycling bottles, cans, or other recyclable articles.

For example, in some embodiments, beverage bottles and cans are printed with a unique code that can be used to help validate whether or not they have been recycled. A user, after finishing their drink, can open a recycling validation application on their personal mobile device, and can take a photograph of the unique code. The mobile application can then communicate with a remote server to authenticate the unique code (e.g., to confirm that the code is validly associated with a recyclable bottle or can).

The user may also use the mobile application to capture information that helps confirm that their bottle or can has been placed in a recycling stream. For example, they may take a photograph of a recycling bin (into which they have placed or plan to place their bottle), or they may allow the mobile application to access their position (e.g., GPS coordinates) to confirm that they are near a known recycling bin. The mobile application may share such information with the remote server. The remote server can then confirm both (1) that the photographed bottle or can is an approved recyclable bottle or can, and (2) that the bottle or can has been placed in a recycling stream. Upon such confirmation, the user may be provided with a reward (e.g., a monetary deposit, a point, a virtual badge, a virtual level increase, a coupon, or access to audio or video content, which may be exclusive to users of the mobile application.). The promise of a reward for recycling acts as an incentive for users to recycle more, thereby increasing personal recycling rates.

These and other embodiments are described below in more detail with reference to the figures.

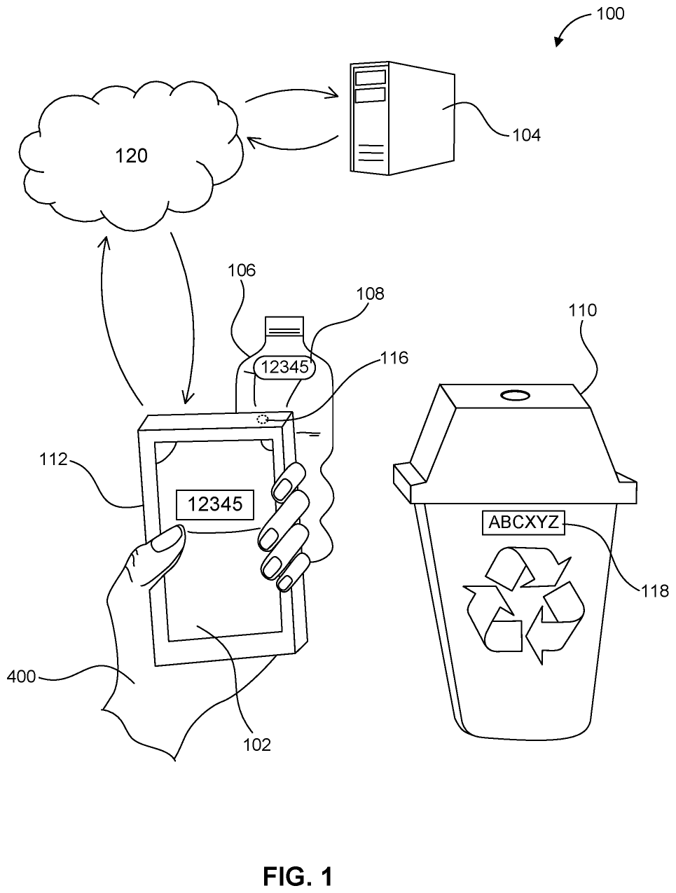

FIG. 1 shows a mobile recycling validation system according to some embodiments. As shown in FIG. 1, mobile recycling validation system 100 may include a mobile application 102 on a user's mobile device 112 and a remote server 104. Mobile application 102 and remote server 104 may communicate wirelessly through a network 120 such as, for example, the Internet or local or wide area networks. Server 104 may be multiple servers.

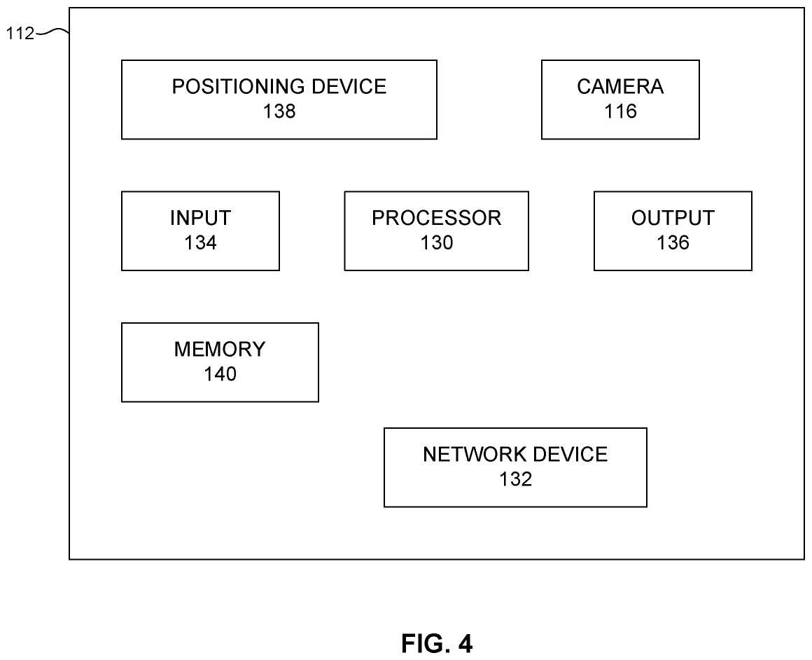

Mobile device 112 may have the functionality of one or more portable devices, such as a cellular telephone, a media player, a personal computer, etc. Mobile device may include a processor 130, a camera 116, a positioning device 138 (e.g., a GPS receiver), and a network device 132, as described in more detail below (see FIG. 4). Mobile device may also include other components common to personal computing and communications devices, such as, for example, an input 134 (e.g., a keypad, microphone, touch screen), an output 136 (e.g., a display screen, speakers, haptic components), and memory 140. These and other components of mobile device 112 may be used to carry out the operations described below.

Mobile recycling validation system 100 may be used to validate a user 400's recycling activity. FIG. 1 also shows user 400 engaged in validating their recycling of a recyclable article 106 (bottle 106) in a recycling container 110 (recycling bin 110). (This system will be described in relation to embodiments relating to recycling a bottle, but it is equally applicable to recyclable cans or other articles.)

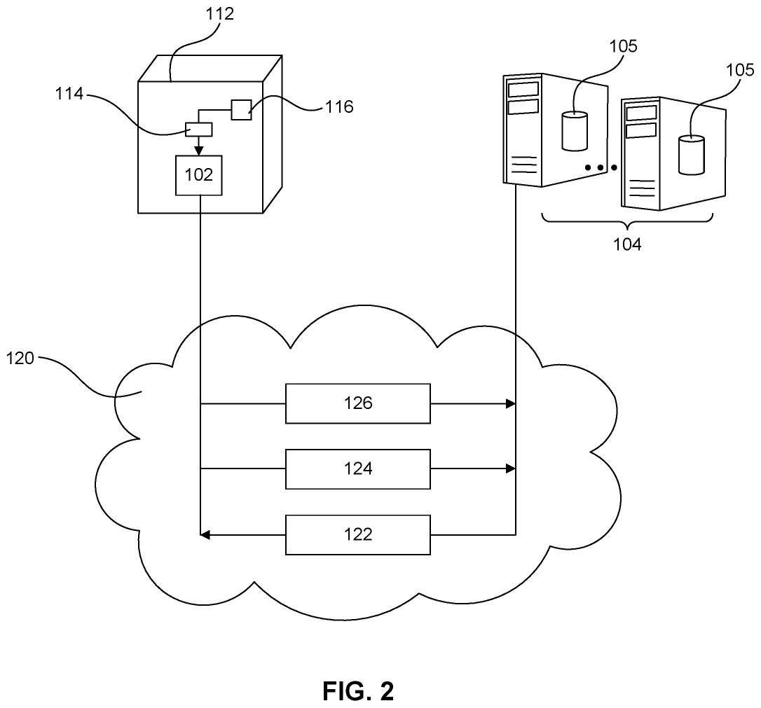

Specifically, user 400 may operate mobile application 102 on mobile device 112 to capture a unique code 108 printed on, or attached to, a recyclable bottle 106 using, for example, a camera 116 built into mobile device 112. Once unique code 108 has been captured by mobile application 102, mobile application 102 may communicate unique code data 126 relating to unique code 108 to at least one remote server 104 via network 120 (see, e.g., FIG. 2).

FIG. 2 illustrates communication between mobile application 102 of mobile device 112 and server 104. In some embodiments, image data 114 captured by camera 116 may be sent by mobile application 102 to server 104 via network 120 (e.g., using network device 132). In some embodiments, image data 114 may include recycling deposit confirmation data 124, and/or unique code data 126.

In some embodiments, server 104 may evaluate unique code data 126 to determine whether unique code 108 is valid, and may evaluate recycling deposit confirmation data 124 to determine whether a bottle has been deposited into the recycling stream. In some embodiments, server 104 may evaluate unique code data 126 and/or recycling deposit confirmation data 124 by comparing the data to data stored in at least one database 105 of server 104. In some embodiments, database 105 may include, for example, a list of approved codes associated with individual recyclable bottles, a list of approved codes associated with individual recycling containers, and/or a list of stored GPS locations of known recycling containers. Server 104 may then produce validation data 122 based on these determinations and communicate validation data 122 to mobile application 102 via network 120. Validation data 122 may include information regarding the validity of unique code 108, and may prompt mobile application 102 to credit the account of the user with an incentive credit, or may prompt mobile application 102 to notify the user that their code is invalid.

In some embodiments, unique code 108 may correspond to identifying information pertaining to recyclable bottle 106. Such identifying information may be used, for example, to facilitate validation of unique code 108 by server 104 such that each unique code 108 can be validated only once. For example, since unique code 108 may be different for every recyclable bottle, server 104 may simply determine whether the code has been previously submitted, such that users may be unable to validate the same code multiple times. Other information may also be used to validate a unique code 108, such as position data derived from positioning device 138 (e.g., GPS coordinates) or time data relating to the position or time of an attempted validation.

Upon receiving confirmation of code validity, or at any other point in the recycling validation process, the user may deposit recyclable bottle 106 in a recycling container 110. Recycling container 110 may be any container designated for collecting recyclable items.

In some embodiments, unique code 108 may include, for example, a numeric code, an alphabetic code, an alphanumeric code, a QR code, or a computer-readable image. In some embodiments, mobile application 102 may utilize, for example, an image recognition feature administered by at least one server which may read the computer-readable image. Additionally, unique code 108 may be a customized code requested by the user. Customized codes may include specific numeric codes, alphabetic codes, alphanumeric codes, QR codes, or computer-readable images that may depict, for example, logos, mascots, symbols, or words.

In some embodiments, unique code 108 may be printed on the recyclable bottle itself or on the bottle cap, printed on a sticker that may be adhered to the recyclable bottle, or printed on a label that may be adhered to the recyclable bottle.

In some embodiments, recycling container 110 may include an additional unique code 118. Unique code 118 may include, for example, a numeric code, an alphabetic code, an alphanumeric code, a QR code, or a computer-readable printed image. Unique code 118 may correspond to identifying information pertaining to recycling container 110. Such identifying information may be used, for example, to provide proof that a user disposed of a recyclable bottle in a recycling container rather than a garbage can. Unique code 118 may be printed or labeled on recycling container 110 by, for example, the manufacturer of the container or the city where the container is being used. Alternatively, unique code 118 may be requested by a user already in possession of a recycling container, and then may be applied via, for example, a sticker or a label. By allowing users to request codes for their recycling containers, users living in towns or cities that do not have municipality-issued recycling containers pre-printed with codes may still be incentivized to recycle while in their own homes.

In some embodiments, mobile application 102 may communicate unique code 118 to server 104 via network 120 in order to confirm that the user has actually deposited recyclable bottle 106 into the recycling stream. Such deposit confirmation data may ensure that the user's unique code submission will only be validated if there is proof that recyclable bottle 106 was deposited into recycling container 110.

In some embodiments, with the permission of the user, mobile application 102 may utilize positioning device 138 (e.g., a GPS receiver) built into mobile device 112 to capture position data of the mobile device, which may be sent to server 104 via network 120, which may then, for example, use an algorithm to compare the position data with a database 105 of stored GPS locations of known recycling containers.

In some embodiments, mobile application 102 may communicate recycling deposit confirmation data 124 provided by unique code 118 with server 104 via network 120. Server 104 may then, for example, use an algorithm to compare unique code 118 to database 105 of approved codes to determine if unique code 118 corresponds to an approved code within database 105. If unique code 118 corresponds to an approved code, server 104 may send validation data 122 to mobile application 102.

In some embodiments, mobile application 102 may utilize an image recognition feature administered by at least one server which may identify whether an image captured by a user includes, for example, an image of a recycling container, such as recycling container 110. In some embodiments, the image recognition feature may also identify whether an image captured by a user additionally includes an image of a recyclable bottle and/or an image of a unique code on the recyclable bottle, for example unique code 108.

To encourage recycling, mobile recycling validation system 100 may reward users with incentive credits for validated recycling. An incentive credit may include, for example, a monetary deposit, a point, a virtual badge, a virtual level increase, a coupon, or access to audio or video content, which may be exclusive to users of the mobile application.

In some places, recyclable bottles and cans may be returned in designated recycling centers for a cash refund; however, such recycling programs may have different requirements and geographical limitations. Conversely, rewards of incentive credits granted by mobile recycling validation system 100 may reward users for recycling, regardless of where they are performing their recycling and without requiring a trip to a specific recycling center.

Furthermore, incentive credits provided by mobile recycling validation system 100 may additionally include rewards other than money, such as, for example, virtual points, badges, and level increases which may be accumulated to reach various reward levels. For example, in some embodiments, once a user accumulates a certain number of virtual points, he or she may redeem the points in exchange for a prize. Greater numbers of points may be used, for example, to redeem prizes having greater value. In some embodiments, the virtual points, badges, and level increases may be used to participate in competitions, or other community-based virtual features with other users.

In some embodiments, mobile application 102 may be linked to a user account that tracks and stores information related to a user's recycling history. For example, the user account may store incentive credits that have been awarded to the user upon submitting recycling data that has been confirmed as valid by the server. Additionally, the user account may keep track of the number of times the user has validly recycled a bottle.

In some embodiments, a user may connect mobile application 102 to a social media account of the user so that the user may share information stored in the user account. By connecting to social media, the user may share their recycling history with their friends connected to their social media accounts, and may also post information and updates about their recycling history directly to their social media accounts. Additionally, mobile application 102 may communicate data with community-based virtual features, administered by at least one server (e.g., server 104), which may allow users to, for example, participate in competitions with other users by, for example, organizing the recycling histories of multiple users into a leaderboard to indicate which user has recycled the most bottles. In some embodiments, users may designate which other users they want to participate in a competition with and may organize their own competitions. For example, a university may organize a competition for its students and professors, which may only be open to members of that university.

For example, in some embodiments, a community-based competition may be either a team-based competition or an individual competition wherein the virtual points of each team or individual are tallied for a certain period of time, and at the end of that period, the team or individual with the most points wins.

In some embodiments, users may compete to collect the most virtual badges, or may challenge themselves to collect certain virtual badges which may be awarded for completing specific tasks. For example, a particular badge may be awarded for validly recycling a threshold number of bottles, while another badge may be awarded for validly recycling bottles in a certain number of different locations, or for validly recycling a threshold number of bottles at one particular location.

Alternatively, in some embodiments, users may be awarded with virtual level increases upon, for example, validly recycling a threshold number of bottles, validly recycling a threshold number of bottles at a particular location, validly recycling bottles at a certain number of different locations, or any combination of the aforementioned tasks. In some embodiments, level increases may be awarded when a certain number of virtual points or badges have been accumulated.

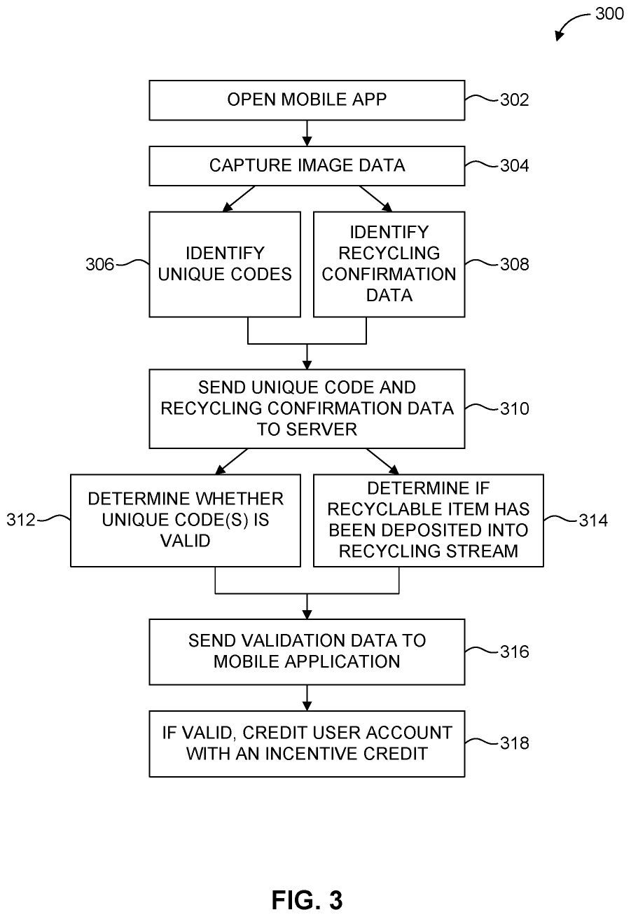

FIG. 3 is a diagram outlining a recycling validation process 300 executed by mobile recycling validation system 100, according to some embodiments. As shown in FIG. 3, when user 400 wants to recycle recyclable bottle 106, user 400 may open mobile recycling application 102 (operation 302) on their mobile device 112 and capture image data 114 using camera 116 built in to mobile device 112 (operation 304). Image data 114 may include a photograph of unique code 108 printed on, adhered to, or otherwise disposed on recyclable bottle 106.

The unique code 108 associated with recyclable bottle 106 may correspond to information about recyclable bottle 106, such as, for example, the type of beverage it contained or where it was purchased. In some embodiments, the user may capture additional image data that includes a photograph of either a recycling container, such as, for example, recycling container 110, or a second unique code 118 printed on, or adhered to, a recycling container. Unique code 118 associated with the recycling container may correspond to information about the recycling container, such as, for example, the location of the recycling container or owner of the recycling container (i.e., the recycling container may be issued by a town or city, owned by a private citizen, owned by a school or business, etc.). In some embodiments, the mobile recycling application may also capture position data separately from the image data by utilizing the mobile device's built-in positioning device 138.

Once image data 114 is captured, mobile application 102 may identify the unique code on recyclable bottle 106 (operation 306), and in some embodiments the unique code on the recycling container 110, as well, and identify unique code data 126 as well as recycling deposit confirmation data 124 (operation 308). Unique code data 124 may include identifying information about unique code 108—since all of the codes corresponding to recyclable bottles are unique, unique code data 124 may be used to determine whether data relating to a single recyclable bottle has been captured more than once. Recycling deposit confirmation data 124 may include, for example, either unique code data 126 associated with a recycling container 110 or a location captured by the positioning device 138 of mobile device 112.

Unique code data 126 and the recycling deposit confirmation data 124 may be sent to one or more servers 104 (operation 310), which may be remote from the mobile device 112. Upon receiving recycling deposit confirmation data 124, server 104 may determine if recycling deposit confirmation data 124 indicates that recyclable bottle 106 has been deposited into the recycling stream (operation 312), (e.g., meaning that it has been deposited in a recycling container rather than thrown away in a garbage can). Server 104 may determine whether recycling deposit confirmation data 124 indicates that the recyclable bottle 106 has been deposited into the recycling stream by evaluating whether recycling deposit confirmation data 124 includes a photograph of either a recycling container or a unique code associated with a recycling container (operation 312). Server 104 may also determine whether recycling deposit confirmation data 124 indicates that recyclable bottle 106 has been deposited into the recycling stream by, for example, using an algorithm to compare the location associated with the recycling container to database 105, which may include a list of approved position coordinates.

Additionally, server 104 may determine if the unique codes associated with both the recyclable bottle 106 and/or the recycling container 110 are valid by, for example, using a code-validation algorithm to compare each unique code to database 105 of all of the valid unique codes that have been issued for recyclable bottles and recycling containers (operation 314).

With regard to the unique codes associated with recyclable bottles, if the unique code being analyzed by the server 104 matches a code stored in database 105, that unique code may be determined to be valid. However, in some embodiments, once unique code 108 has been matched with a code stored in database 105, that code will expire, and if the same user, or another user, attempts to resubmit that code for validation, it may be determined to be invalid.

With regard to the unique codes associated with recycling containers, similarly to the unique codes associated with the recyclable bottles, if the unique code being analyzed matches a code stored in database 105, it may be determined to be valid (operation 314). But, that code will not expire once matched, since recyclable containers may be used over and over to collect a multitude of recyclable bottles over a period of time.

Upon verifying that the unique code and recycling deposit confirmation data are valid, the server may send validation data 122 to the mobile recycling application 102 (operation 316) and credit a user account connected to mobile recycling application 102 with an incentive credit (operation 318), which may include a monetary deposit, a point, a virtual badge, a virtual level increase, a coupon, or access to audio or video content, which may be exclusive to users of the mobile application.

With reference to FIG. 4, mobile device 112 and servers 104 may include components and capability sufficient to carry out the above-described functions, as would be understood by one of skill in the art.

For example, mobile device 112 may allow a user to connect to and communicate through a network (e.g., network 120). The mobile device 112 may include one or more processors 130 that provide the processing capability used to execute its operating system, applications, and other functions of mobile device 112. The one or more processors 130 may include general and special purpose microprocessors and/or a combination thereof. Processor(s) 130 also may include on-board memory.

Mobile device 112 may also include storage memory for storing data used for operating processor as well as other data used by mobile device 112. Mobile device 112 may also include one or more network devices 132 for receiving and transmitting information over one or more communications channels. Network device 132 may include a wide area network (WAN) interface that permits connection to the Internet via a cellular communications network. Network device 132 may also include a personal area network (PAN) interface for connecting to a PAN such as a Bluetooth® network, an IEEE 802.15.4 (ZigBee) network, or an ultra wideband (UWB) network. Network device 132 may interact with or include an antenna to transmit and receive radio frequency signals of the network. Network device 132 may include any number and combination of network interfaces.

Mobile device 112 may also include a positioning device 138 used to determine geographical position. Positioning device 138 may utilize the global positioning system (GPS) or a regional or site-wide positioning system that uses cell tower positioning technology or WiFi technology, for example.

Mobile device 102 may also include a camera or other optical sensor 116.

Server 104 may be any type of server suitable to perform the functions described above (e.g., application servers, web servers, etc.) In some embodiments, server 104 may be an application server that includes any appropriate hardware and software as needed to execute aspects of one or more applications for mobile device 112. For example, server 104 can be an application server that is able to generate content such as text, graphics, audio, and/or video to be transferred to mobile device 112, which may be served to the user of mobile device 102.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A mobile recycling validation system, comprising:
a mobile recycling application operating on a user's mobile device; and
at least one server remote from the mobile device,
wherein the mobile recycling application is configured to:
receive image data relating to an image captured with a camera of the mobile device,
identify a unique code printed on a recyclable item depicted in the image,
determine unique code data relating to the unique code,
determine recycling deposit confirmation data, which includes data that can be used to indicate whether the recyclable item has been deposited in a recycling stream,
send the unique code data and the recycling deposit confirmation data to the at least one server,
wherein the at least one server is configured to:
receive the unique code data and the recycling deposit confirmation data,
determine if the unique code is valid,
determine if the recycling deposit confirmation data indicates that the recyclable item has been deposited in the recycling stream;
send validation data to the mobile recycling application, wherein the validation data includes an indication of whether the unique code was determined to be valid and whether the recyclable item was determined to have been deposited in the recycling stream;
wherein, if the validation data indicates that the unique code was determined to be valid and that the recyclable item was determined to have been deposited in the recycling stream, the mobile recycling validation system credits an account of the user with an incentive credit.

2. The mobile recycling validation system of claim 1, wherein the mobile recycling application is further configured to receive second image data relating to a second image captured with the camera of the mobile device, and
wherein the recycling deposit confirmation data is based on the second image data.

3. The mobile recycling validation system of claim 2, wherein the at least one server is configured to determine if the recycling deposit confirmation data indicates that the recyclable item has been deposited in the recycling stream by determining whether the second image contains at least one of: a recycling container or a second unique code associated with a recycling container.

4. The mobile recycling validation system of claim 1, wherein the recycling deposit confirmation data is associated with a GPS location.

5. The mobile recycling validation system of claim 1, wherein the at least one server is configured to determine if the unique code is valid by using a code-validation algorithm to compare the unique code to a database of valid codes.

6. The mobile recycling validation system of claim 1, wherein the incentive credit comprises at least one of: a monetary deposit, a point, a virtual badge, a virtual level increase, a coupon, or access to audio or video content.

7. The mobile recycling validation system of claim 1, wherein the at least one server is further configured to store information about a recycling history of the user.

8. The mobile recycling validation system of claim 1, wherein the mobile application is configured to post information about the user's recycling history to a social media account of the user.

9. The mobile recycling validation system of claim 1, further comprising a community feature, wherein the community feature compares data associated with the user's recycling history with data associated with a second user's recycling history and produces a leaderboard.

10. The mobile recycling validation system of claim 9, wherein the community feature is administered by the at least one server.

11. A method for mobile validation of recycling, comprising:
processing image data, the image data relating to a recyclable item to determine if the recyclable item is eligible for an incentive credit;
processing data relating to a recycling container to determine if the recyclable item has been deposited in a recycling stream; and
if the recyclable item has been determined to have been deposited in a recycling stream, crediting an account of a user with an incentive credit.

12. The method of claim 11, wherein processing the image data relating to the recyclable item to determine if the recyclable item is eligible for an incentive credit comprises:
receiving the image data, wherein the image data originated from a camera of a user's personal computing device;
identifying in the image data a unique code of the recyclable item; and
determining if the unique code is valid.

13. The method of claim 12, wherein determining if the unique code is valid comprises at least one of:
utilizing a code-validation algorithm; or
comparing the unique code to a database of valid codes to determine whether the unique code matches a valid code within the database.

14. The method of claim 11, wherein the data relating to a recycling container is second image data that originated from a camera of a personal computing device of the user, and
wherein processing the data relating to a recycling container to determine if the recyclable item has been deposited in a recycling stream comprises determining whether the second image data indicates that the recyclable item has been deposited in the recycling stream.

15. The method of claim 14, wherein determining whether the second image data indicates that the recyclable item has been deposited in the recycling stream comprises at least one of:
identifying in the second image data a code of the recycling container and validating the recycling container code; or
processing the second image data to determine whether its image depicts a recycling container.

16. The method of claim 15, wherein validating the code of the recycling container comprises
using a code-validation algorithm to compare the unique code to a database of valid codes to determine whether the container code matches a valid container code within the database.

17. The method of claim 11, wherein the data relating to a recycling container is GPS data that originated from a personal computing device of the user, and
wherein processing the data relating to the recycling container to determine if the recyclable item has been deposited in a recycling stream comprises determining whether the GPS data corresponds to approved geographic coordinates.

18. The method of claim 11, wherein the incentive credit comprises at least one of: a monetary deposit, a point, a virtual badge, a virtual level increase, a coupon, or access to audio or video content.

19. The method of claim 11, further comprising tracking information about a recycling history of the user.

20. The method of claim 11, further comprising posting updates about a recycling history of the user to a social media account of the user.

21. The method of claim 11, further comprising comparing data associated with the user's recycling history with data associated with a second user's recycling history; and
producing a leaderboard based on a comparison of the first user's recycling history and the second user's recycling history.

22. A mobile recycling validation system, comprising:
recyclable bottles, each comprising a unique bottle code;
a mobile recycling application configured to receive image data relating to images captured with a camera of a mobile device; and
a server remote from the mobile device; wherein the server is configured to receive and analyze data from the mobile recycling application to determine whether it includes image data that depicts a bottle with a valid unique bottle code and data indicating that the bottle was recycled.

23. The mobile recycling validation system of claim 22, further comprising recycling containers, each comprising a unique recycling container code,
wherein the server is configured to determine whether the data from the mobile recycling application includes data indicating that the bottle was recycled by determining whether it includes image data that depicts a recycling container with a valid recycling container code.

24. The mobile recycling validation system of claim 22, wherein the server comprises a database of unique bottle codes, and
wherein the validity of each unique bottle code within the database expires after being matched with a unique bottle code depicted in the image data.

25. The mobile recycling validation system of claim 24, wherein the database further comprises a plurality of valid recycling container codes, and
wherein determining whether the data received by the mobile application includes image data that depicts a recycling container with a valid recycling container code comprises comparing the image data to the valid recycling container codes within the database.
